(19) United States
(12) Patent Application Publication
(10) Pub. No.: US 2017/0175897 A1
(43) Pub. Date: Jun. 22, 2017

(54) SEAL ASSEMBLY

(71) Applicant: Lars Thomas Johansson, Yven (NO)

(72) Inventor: Lars Thomas Johansson, Yven (NO)

(21) Appl. No.: 15/383,807

(22) Filed: Dec. 19, 2016

(30) Foreign Application Priority Data
Dec. 20, 2015 (NO) 20151756

(51) Int. Cl. F16J 15/3216; F16C 33/78; F16J 15/3232

(52) U.S. Cl. CPC F16J 15/3216; F16J 15/3232; F16C 33/7823; F16C 33/7826

(57) ABSTRACT

The invention is a seal comprising inner (308) and outer (301) circular seal members wherein the seal members are rotatable with respect to each other, where said outer seal member (301) is arranged to be fixed inside an outer circular body, and an inner circular circumferential of said inner seal member (308) is arranged to be fixed about an inner circular body rotating inside said outer circular body, wherein the seal comprises a first intermediate seal member (302) with a common seal interface (320a, 320b) with said inner seal member, wherein said common seal interface comprises a seal lip and an adjacent inner counterface, and said first intermediate seal member is rotatable relative said inner and outer seal members.

### TECHNICAL FIELD

The present invention relates to the field of seals and can be used where there is a need for a seal between a fixed and a rotating body. The seal device is especially suitable for high rotational speeds and/or where it is desirable with low friction.

### BACKGROUND

The present invention relates to any seals, but especially seals applied in rolling and/or ball bearings and between a fixed and a rotating component. In a seal between a fixed and a rotating component it is difficult to combine high normal load which the seal exerts on the movable body with low friction. It is also difficult to combine low friction with high rotational speed and good sealing properties.

Known seals have a relatively short lifetime due to friction and wear and they consume a lot of energy. For instance, lip seals can account for approximately 75% of the total bearing power loss. It is desirable with extended service life and a more energy efficient solution. The function of a seal can both be to separate two media, protect against ingress of pollutants, retain the lubricant or retain the pressure between a fixed and a movable body.

Friction force/torque can be recognized as the limiting factors in the case of the seals operating on the high-speed shafts. Elastomer lip seals sealing the engine crankshafts generate relatively small torque, but their power consumption is large due to high angular speeds. Combined with small heat conduction, the friction loss increases temperature at the sealing interface. This leads to seal ageing, wear and a reduced service life. It is possible to reduce frictional loss, either through decreasing normal load which the seal exerts on the movable body or by means of decreasing the friction coefficient. Patent US20080309013 A1 and patent U.S. Pat. No. 4,266,786 describes a mechanical seal that aims to extend service life, reduced wear and less heat is generated through the use of a freely rotatable central seal ring. Patent WO2013076196 aims to reduce friction and wear at elevated temperatures through a temperature sensitive actuator that decreases normal load witch the seal exerts on the rotating body.

### SHORT SUMMARY OF THE INVENTION

This invention reduces friction, wear and heat through a seal comprising inner and outer circular seal members wherein the seal members are rotatable with respect to each other. This yields a reduced relative motion at the seal interface. This leads to an extended service life, a reduction in friction and enables higher rotational speeds.

An object of the present invention is to deal with the previously mentioned disadvantages.

It is a particular object of the present invention to provide a seal that is easy to install, that prevents the lubricant from leaking, even under the effect of an increased pressure inside the sealed component, and that can prevent the influx of moisture, dust or other bodies.

It is a particular object of the present invention to provide a seal with improved friction, wear and tear properties and an extended service life.

The invention is a seal comprising inner and outer circular seal members wherein the seal members are rotatable with respect to each other, where said outer seal member is arranged to be fixed inside an outer circular body, and an inner circular circumferential of said inner seal member is arranged to be fixed about an inner circular body rotating inside said outer circular body, wherein the seal comprises a first intermediate seal member (302) with a common seal interface (320a, 320b) with said inner seal member, wherein said common seal interface comprises a seal lip and an adjacent inner counterface, and said first intermediate seal member is rotatable relative said inner and outer seal members.

### FIGURE CAPTIONS

An illustrative and non-limiting embodiment of the present invention will be described below in detail with reference to the appended drawings, in which:

FIGS. 1, 2, 3, 5, 6 and 9 illustrates different embodiments of the invention according to a partial cross section of a radial seal comprising intermediate seal members.

FIGS. 3a and 6a illustrates the common seal interface between seal members.

FIGS. 4, 10 and 11 illustrates different embodiments of the invention according to a partial cross section of a bearing seal comprising intermediate seal members.

### EMBODIMENTS OF THE INVENTION

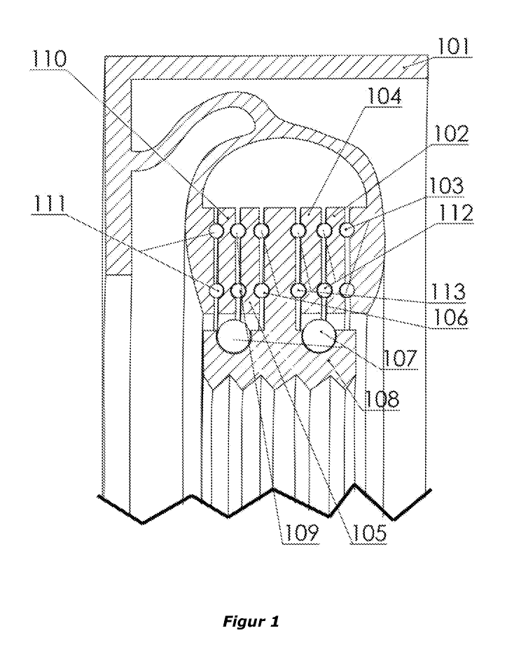

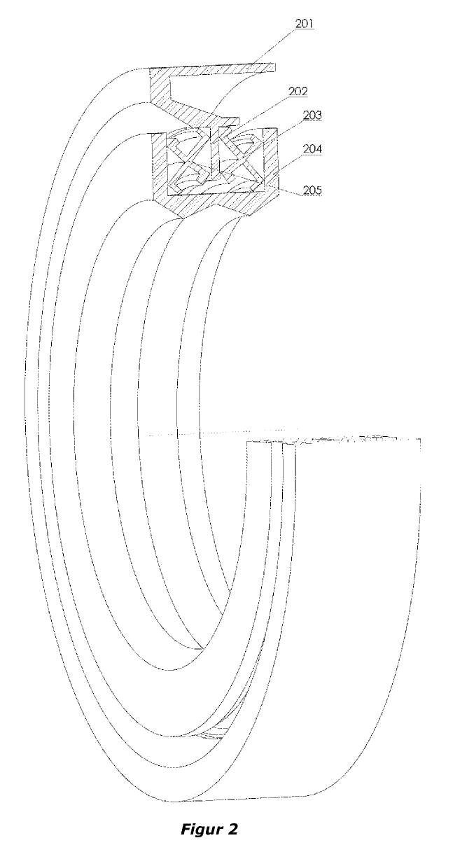

An embodiment of the invention illustrated by FIG. 1 is a partial cross section view of a radial seal comprising intermediate seal members. An outer seal member 101 is arranged to be fixed inside an outer body, such as a housing bore. The inner part of the outer seal member is in contact with a first intermediate seal member 103 and 111 and has a common seal interface at the contact surface between the outer seal member and the first intermediate seal. The first intermediate seal members 103 and 111 is arranged between the outer seal member and second intermediate seal members 110 and 102. The outer part of the first intermediate seal member is in contact with the outer seal member.

The inner part of the first intermediate seal member is in contact with the second intermediate seal member. The first intermediate seal has common seal interfaces at the contact surface between outer seal member and second intermediate seal member. The first intermediate seal member is freely rotatable relative to the outer seal member 101 and the second intermediate seal members 110 and 102.

The outer part of the second intermediate seal member is in contact with the inner part of the first intermediate seal member and the inner part of second intermediate seal is in contact with a third intermediate seal member 109 and 112. The second intermediate seal has common seal interfaces at the contact surface between first and third intermediate seal members. The second intermediate seal member is freely rotatable relative to the first and third intermediate seal members.

The outer part of the third intermediate seal member is in contact with the inner part of the second intermediate seal member and the inner part of third intermediate seal is in contact with a fourth intermediate seal member 105 and 104. The third intermediate seal has common seal interfaces at the contact surface between second and fourth intermediate seal members. The third intermediate seal member is freely rotatable relative to the second and fourth intermediate seal members.

The outer part of the fourth intermediate seal member is in contact with the inner part of the third intermediate seal member and the inner part of fourth intermediate seal is in contact with a fifth intermediate seal member 106 and 113. The fourth intermediate seal has common seal interfaces at the contact surface between third and fifth intermediate seal members. The fourth intermediate seal member is freely rotatable relative to the third and fifth intermediate seal members.

The outer part of the fifth intermediate seal member is in contact with the inner part of the fourth intermediate seal member and the inner part of fifth intermediate seal is in contact with an inner seal member 108. The fifth intermediate seal has common seal interfaces at the contact surface between fourth intermediate seal and inner seal member. The fifth intermediate seal member is freely rotatable relative to the fourth intermediate seal and inner seal member.

The inner seal 108 member comprises springs grooves to accommodate a spring 107. The inner seal is to be arranged fixed about an inner body, such as a shaft. In embodiment illustrated in FIG. 1, the inner seal member rotates together with the inner body. To reduce the friction coefficient and wear, it is preferred that the common seal interface comprises one metal part and one elastomeric/polymeric part. In an embodiment, the first, third and fifth intermediate seals comprise a metal material and the inner, outer seal and second and fourth intermediate seals comprise an elastomer/polymeric material to reduce friction and wear.

An embodiment of the invention illustrated by FIG. 2 is a partial cross section view of a radial seal comprising intermediate seal members. An outer seal member 201 is arranged to be fixed inside an outer body, such as a housing bore. The inner part 202 of the outer seal member is in contact with a first intermediate seal member 205 and 203 and has a common seal interface at the contact surface between the outer seal member and the first intermediate seal. The first intermediate seal members 205 and 203 is arranged between the outer and inner seal members 202 and 204. The outer part of the first intermediate seal member is in contact with the outer and seal member and the inner part of the first intermediate seal member in contact with the inner seal member. The first intermediate seal member is freely rotatable relative to the outer seal member 201, 202 and the inner seal member 204.

The inner seal is to be arranged fixed about an inner body, such as a shaft. In embodiment illustrated in FIG. 2, the inner seal rotates with the inner body. To reduce the friction coefficient and wear, it is preferred that the common seal interface comprises one metal part and one elastomeric/polymeric part. In an embodiment, the first intermediate seal comprise a metal material and the inner and outer seal members comprise an elastomer/polymeric material to reduce friction and wear.

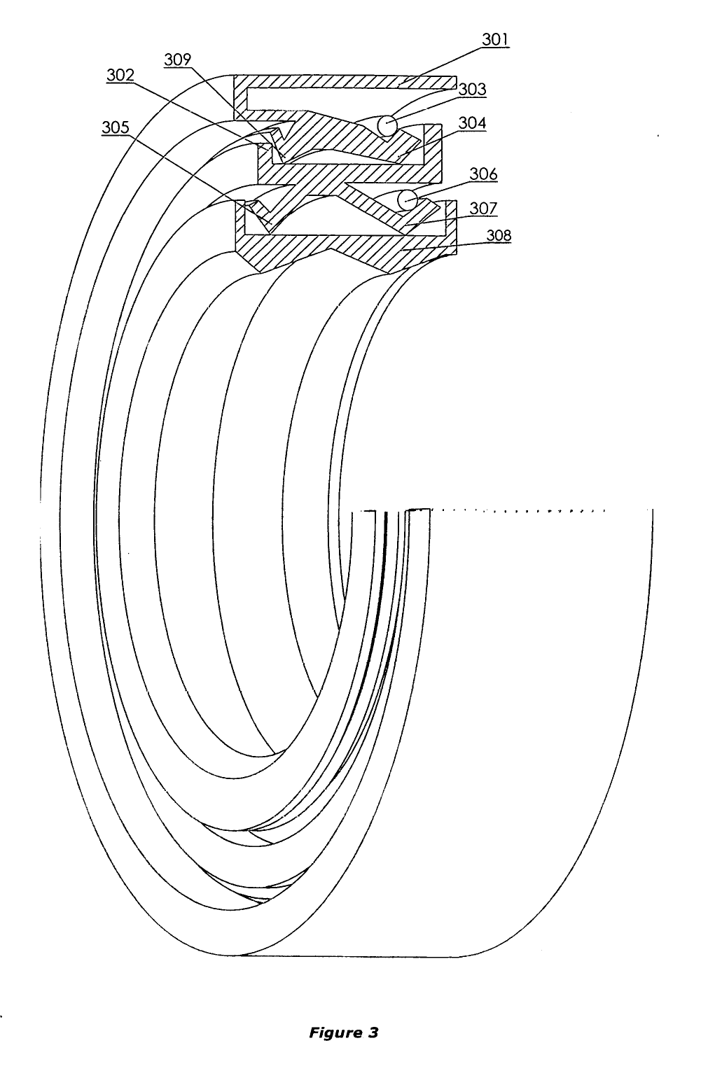

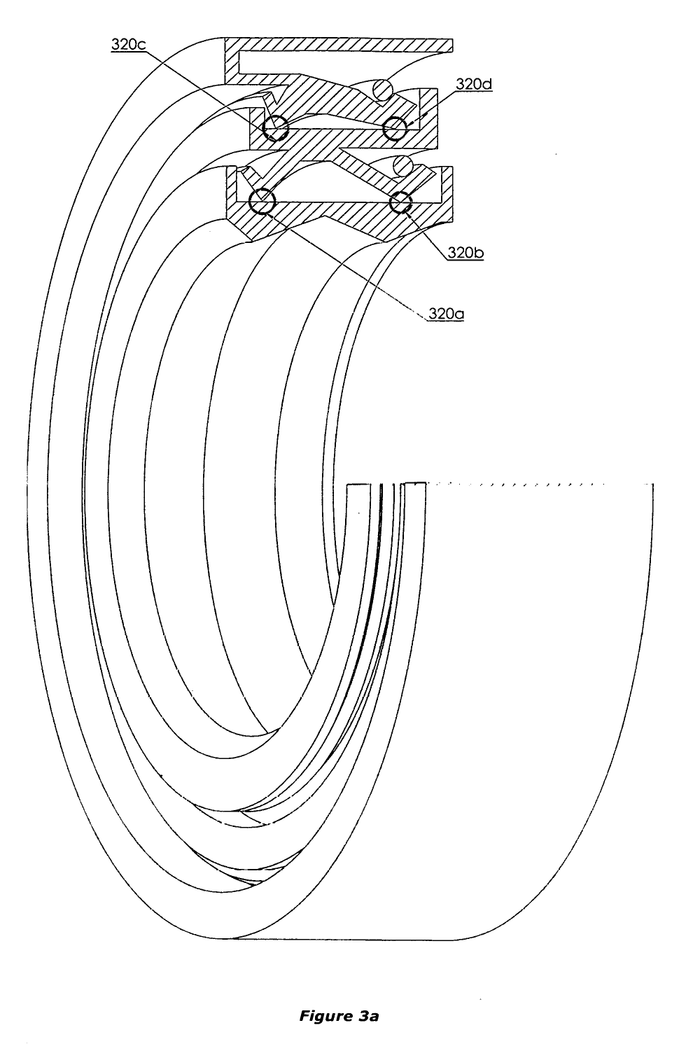

An embodiment of the invention illustrated by FIGS. 3 and 3a is a partial cross section view of a radial seal comprising intermediate seal members. An outer seal member 301 is arranged to be fixed inside an outer body, such as a housing bore. The inner part of the outer seal member is in contact with a first intermediate seal member 302 and has a common seal interface 320c and 320d at the contact surface between the outer seal member and the first intermediate seal 302. The outer seal member comprises seal lips 304 and 309. The outer spring 303 exerts a radial force on inner lip 304 to ensure the lip to be in sealing contact with the counterface on the first intermediate seal. The outer part of the first intermediate seal member is in contact with the inner part of the outer seal member and the inner part of first intermediate seal is in contact with the inner seal member 308. The first intermediate seal member comprises seal lips 305 and 307. The spring 306 exerts a radial force on inner lip 307 to ensure the lip to be in sealing contact with the counterface on the inner seal member. The first intermediate seal has common seal interfaces 320a and 320b at the contact surface between first intermediate seal member and inner seal member. The first intermediate seal member is freely rotatable relative to the outer and inner seal member.

The inner seal member 308 is to be arranged fixed about an inner body, such as a shaft. To reduce the friction coefficient and wear, it is preferred that the common seal interface 320a-320c comprises one metal surface and one elastomeric/polymeric surface. In an embodiment, the first intermediate seal member has a metallic surface towards the outer seal member and a polymeric surface toward the inner seal member. The inner seal member has a metallic surface toward the first intermediate seal member in order to reduce friction and wear.

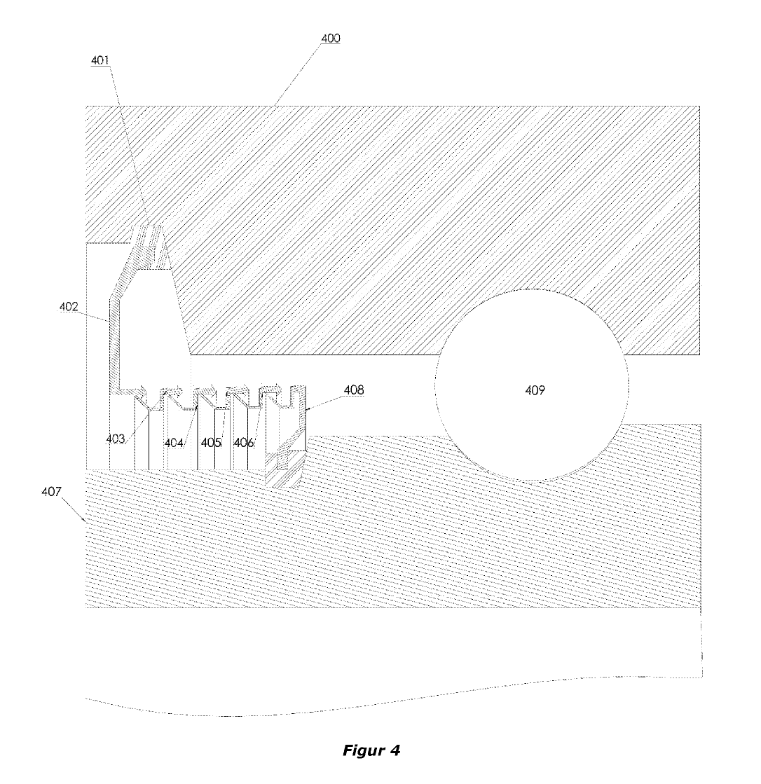

An embodiment of the invention illustrated by FIG. 4 is a partial cross section view of a radial seal comprising intermediate seal members. An outer seal member 401 is arranged to be fixed inside an outer body, such as en outer bearing ring 400. The inner part 402 of the outer body is in contact with a first intermediate seal member 403 and has a common seal interface at the contact surface between the outer seal member and the first intermediate seal. The first intermediate seal member 403 is arranged between the outer seal member and second intermediate seal members 404. The outer part of the first intermediate seal member is in contact with the outer seal member. The inner part of the first intermediate seal member is in contact with the second intermediate seal member. The first intermediate seal has common seal interfaces at the contact surface between outer seal member and second intermediate seal member. The first intermediate seal member is freely rotatable relative to the outer seal member 402 and the second intermediate seal member 404.

The outer part of the second intermediate seal member is in contact with the inner part of the first intermediate seal member and the inner part of second intermediate seal is in contact with a third intermediate seal member 405. The second intermediate seal has common seal interfaces at the contact surface between first and third intermediate seal members. The second intermediate seal member is freely rotatable relative to the first and third intermediate seal members.

The outer part of the third intermediate seal member is in contact with the inner part of the second intermediate seal member and the inner part of third intermediate seal is in contact with a fourth intermediate seal member 406. The third intermediate seal has common seal interfaces at the contact surface between second and fourth intermediate seal members. The third intermediate seal member is freely rotatable relative to the second and fourth intermediate seal members.

The outer part of the fourth intermediate seal member is in contact with the inner part of the third intermediate seal member and the inner part of fourth intermediate seal is in contact with an inner seal member 408. The fourth intermediate seal has common seal interfaces at the contact surface between third intermediate seal and inner seal member. The fourth intermediate seal member is freely rotatable relative to the third intermediate seal and inner seal member.

The inner seal member 408 is to be arranged fixed about an inner body, such as inner bearing ring 407. To reduce the friction coefficient and wear, it is preferred that the common seal interface comprises one metal part and one elastomeric/polymeric part.

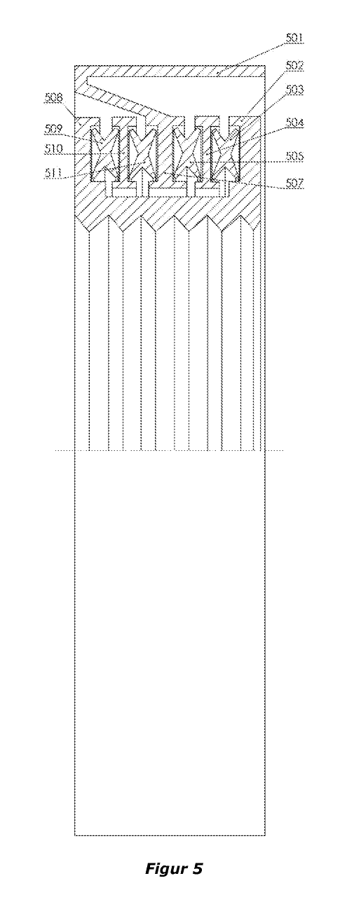

An embodiment of the invention illustrated by FIG. 5 is a partial cross section view of a radial seal comprising intermediate seal members. An outer seal member 501 is arranged to be fixed inside an outer body, such as a housing bore. The inner part of the outer seal member 507 is in contact with a first intermediate seal member 505 and 511 and has a common seal interface at the contact surface between the outer seal member and the first intermediate seal. The first intermediate seal members 505 and 511 is arranged between the outer seal member and second intermediate seal members 504 and 510. The outer part of the first intermediate seal member is in contact with the outer seal member. The inner part of the first intermediate seal member is in contact with the second intermediate seal member. The first intermediate seal has common seal interfaces at the contact surface between outer seal member and second intermediate seal member. The first intermediate seal member is freely rotatable relative to the outer seal member 507 and the second intermediate seal members 504 and 510.

The outer part of the second intermediate seal member is in contact with the inner part of the first intermediate seal member and the inner part of second intermediate seal is in contact with a third intermediate seal member 503 and 509. The second intermediate seal has common seal interfaces at the contact surface between first and third intermediate seal members. The second intermediate seal member is freely rotatable relative to the first and third intermediate seal members.

The outer part of the third intermediate seal member is in contact with the inner part of the second intermediate seal member and the inner part of third intermediate seal is in contact with an inner seal member 508 and 502. The third intermediate seal has common seal interfaces at the contact surface between second intermediate seal and inner seal member. The third intermediate seal member is freely rotatable relative to the second intermediate seal and inner seal member.

The inner seal member 502 and 508 is to be arranged fixed about an inner body, such as a shaft. To reduce the friction coefficient and wear, it is preferred that the common seal interface comprises one metal surface and one elastomeric/polymeric surface. In an embodiment, the first and third intermediate seals are formed of an elastomer/polymeric material. The inner and outer seal members and second intermediate seals comprises a metal surface facing first and third intermediate seals in order to reduce friction and wear.

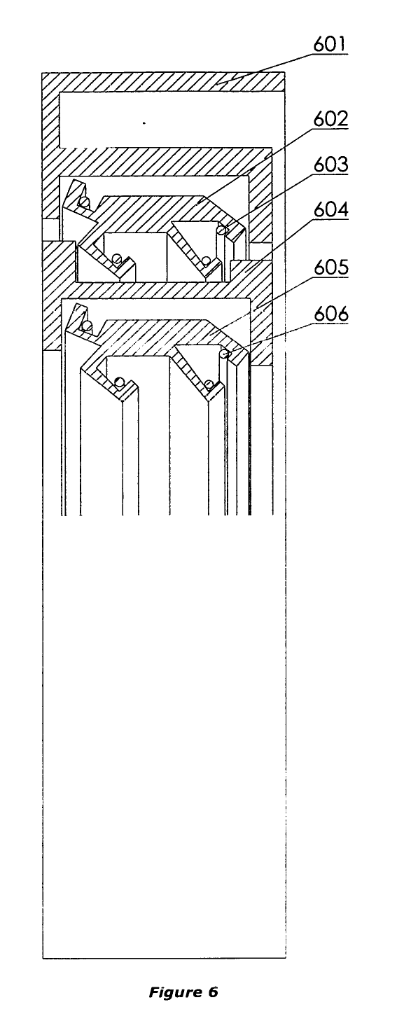

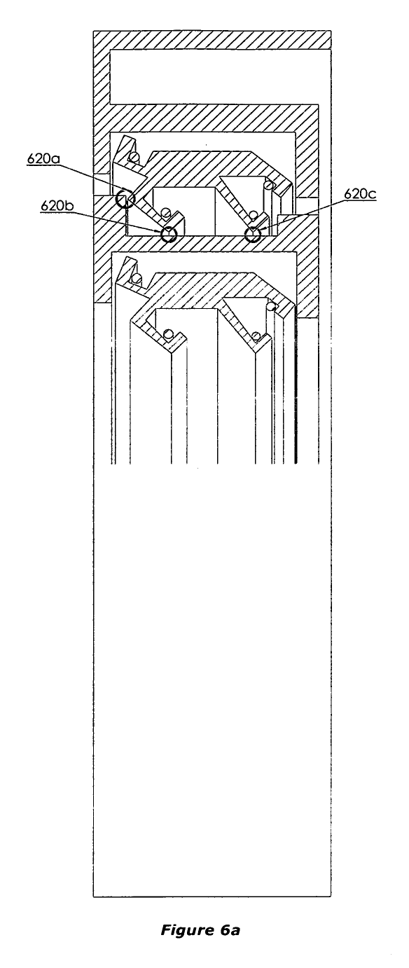

An embodiment of the invention illustrated by FIGS. 6 and 6a is a partial cross section view of a radial seal comprising intermediate seal members. An outer seal member 601 is arranged to be fixed inside an outer body, such as a housing bore. The inner part of the outer seal member is in contact with a first intermediate seal member 602 and has a common seal interface at the contact surface between the outer seal member and the first intermediate seal. The first intermediate seal member 602 is arranged between the outer seal member and second intermediate seal member 604. The outer part of the first intermediate seal member is in contact with the outer seal member. The inner part of the first intermediate seal member has common seal interfaces 620a, 620b and 620c with the second intermediate seal member. The first intermediate seal has common seal interfaces at the contact surface between outer seal member and second intermediate seal member. The first intermediate seal member is freely rotatable relative to the outer seal member 601 and the second intermediate seal member 604.

The outer part of the second intermediate seal member is in contact with the inner part of the first intermediate seal member and the inner part of second intermediate seal is in contact with the inner seal member 605. The second intermediate seal has common seal interfaces at the contact surface between first intermediate seal and inner seal member. The second intermediate seal member is freely rotatable relative to the first intermediate seal member and inner seal member.

The inner seal member 605 is to be arranged fixed about an inner body, such as a shaft. To reduce the friction coefficient and wear, it is preferred that the common seal interface comprises one metal surface and one elastomeric/polymeric surface. In an embodiment, the first intermediate seal member and inner seal member are formed of an elastomer/polymeric material. The outer seal member and second intermediate seals comprises a metal surface facing first intermediate seal and inner intermediate seal in order to reduce friction and wear.

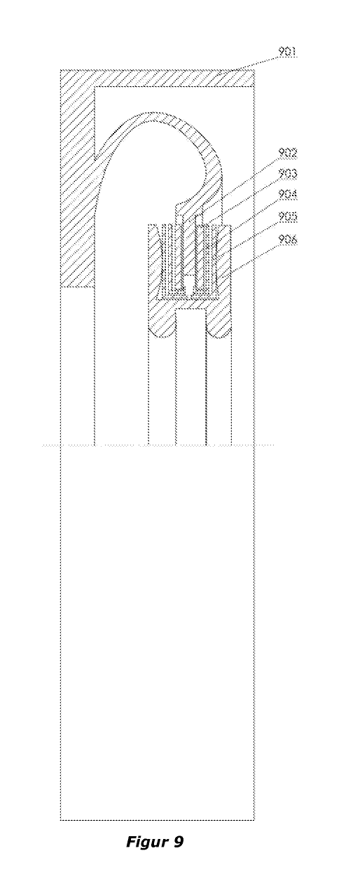

An embodiment of the invention illustrated by FIG. 9 is a partial cross section view of a radial seal comprising intermediate seal members. An outer seal member 901 is arranged to be fixed inside an outer body, such as a housing bore. The inner part of the outer seal member 902 is in contact with a first intermediate seal member 903 and has a common seal interface at the contact surface between the outer seal member and the first intermediate seal. The first intermediate seal members 903 is arranged between the outer seal member and second intermediate seal members 904. The outer part of the first intermediate seal member is in contact with the outer seal member. The inner part of the first intermediate seal member is in contact with the second intermediate seal member. The first intermediate seal has common seal interfaces at the contact surface between outer seal member and second intermediate seal member. The first intermediate seal member is freely rotatable relative to the outer seal member 902 and the second intermediate seal members 904.

The outer part of the second intermediate seal member is in contact with the inner part of the first intermediate seal member and the inner part of second intermediate seal is in contact with a third intermediate seal member 905. The second intermediate seal has common seal interfaces at the contact surface between first and third intermediate seal members. The second intermediate seal member is freely rotatable relative to the first and third intermediate seal members.

The outer part of the third intermediate seal member is in contact with the inner part of the second intermediate seal member and the inner part of third intermediate seal is in contact with an inner seal member 906. The third intermediate seal has common seal interfaces at the contact surface between second intermediate seal and inner seal member. The third intermediate seal member is freely rotatable relative to the second intermediate seal and inner seal member.

The inner seal member 906 is to be arranged fixed about an inner body, such as a shaft. To reduce the friction coefficient and wear, it is preferred that the common seal interface comprises one metal surface and one elastomeric/polymeric surface. In an embodiment, the first and third intermediate seals are formed of an elastomer/polymeric material. The inner and outer seal members and second intermediate seals comprises a metal surface facing first and third intermediate seals in order to reduce friction and wear.

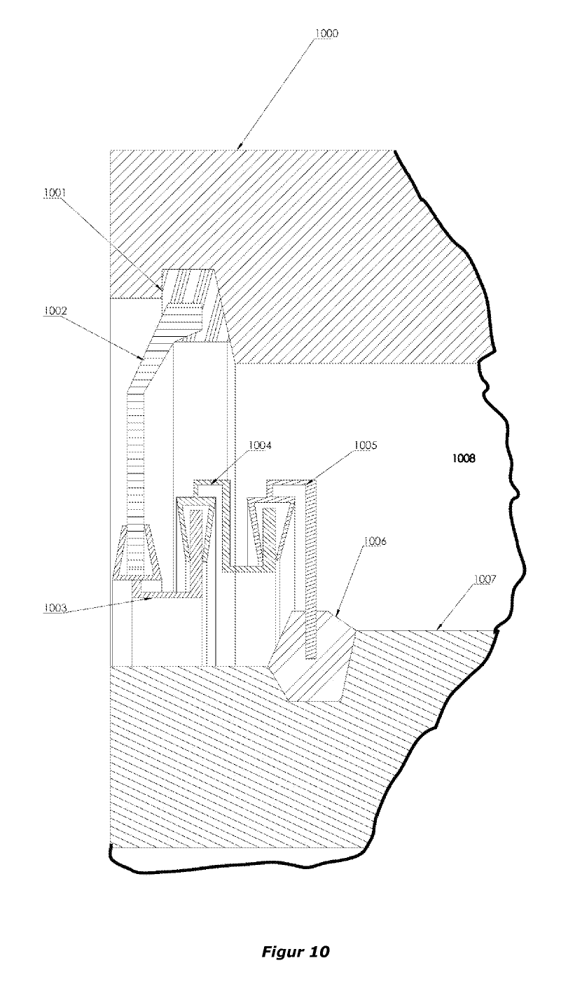

An embodiment of the invention illustrated by FIG. 10 is a partial cross section view of a radial seal comprising intermediate seal members. An outer seal member 1001 is arranged to be fixed inside an outer body, such as en outer bearing ring 1000. The inner part 1002 of the outer body is in contact with a first intermediate seal member 1003 and has a common seal interface at the contact surface between the outer seal member and the first intermediate seal. The first intermediate seal member 1003 is arranged between the outer seal member and second intermediate seal members 1004. The outer part of the first intermediate seal member is in contact with the outer seal member. The inner part of the first intermediate seal member is in contact with the second intermediate seal member. The first intermediate seal has common seal interfaces at the contact surface between outer seal member and second intermediate seal member. The first intermediate seal member is freely rotatable relative to the outer seal member 1002 and the second intermediate seal member 1004.

The outer part of the second intermediate seal member is in contact with the inner part of the first intermediate seal member and the inner part of second intermediate seal is in contact with inner seal member 1005. The second intermediate seal has common seal interfaces at the contact surface between first intermediate seal member and inner seal member 1005. The second intermediate seal member is freely rotatable relative to the first intermediate seal member and inner seal member.

The inner seal member 1006 is to be arranged fixed about an inner body, such as inner bearing ring 1007. To reduce the friction coefficient and wear, it is preferred that the common seal interface comprises one metal part and one elastomeric/polymeric part.

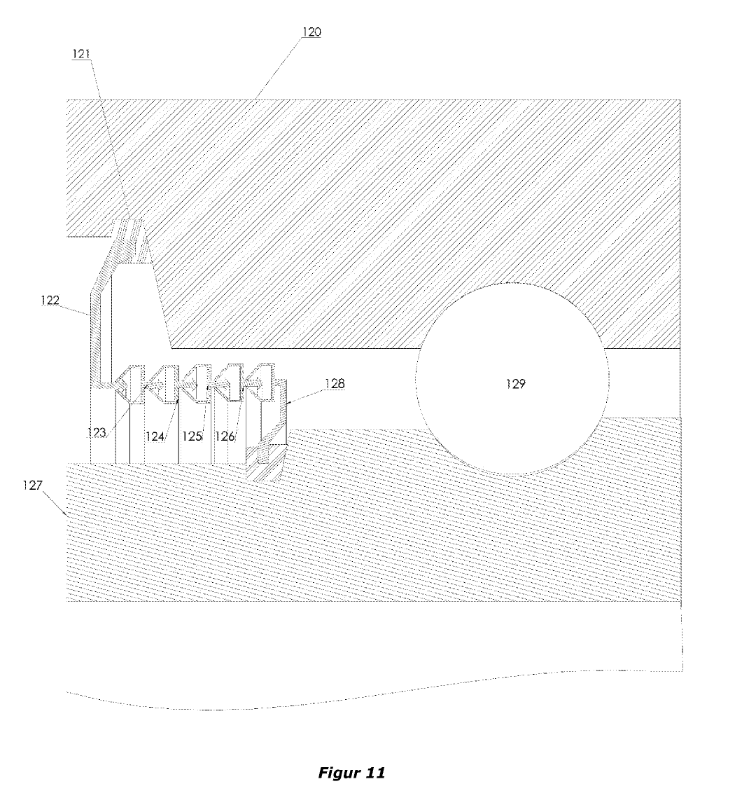

An embodiment of the invention illustrated by FIG. 11 is a partial cross section view of a radial seal comprising intermediate seal members. An outer seal member 121 is arranged to be fixed inside an outer body, such as en outer bearing ring 120. The inner part 122 of the outer body is in contact with a first intermediate seal member 123 and has a common seal interface at the contact surface between the outer seal member and the first intermediate seal. The first intermediate seal member 123 is arranged between the outer seal member and second intermediate seal members 124. The outer part of the first intermediate seal member is in contact with the outer seal member. The inner part of the first intermediate seal member is in contact with the second intermediate seal member. The first intermediate seal has common seal interfaces at the contact surface between outer seal member and second intermediate seal member. The first intermediate seal member is freely rotatable relative to the outer seal member 122 and the second intermediate seal member 124.

The outer part of the second intermediate seal member is in contact with the inner part of the first intermediate seal member and the inner part of second intermediate seal is in contact with a third intermediate seal member 125. The second intermediate seal has common seal interfaces at the contact surface between first and third intermediate seal members. The second intermediate seal member is freely rotatable relative to the first and third intermediate seal members.

The outer part of the third intermediate seal member is in contact with the inner part of the second intermediate seal member and the inner part of third intermediate seal is in contact with a fourth intermediate seal member 126. The third intermediate seal has common seal interfaces at the contact surface between second and fourth intermediate seal members. The third intermediate seal member is freely rotatable relative to the second and fourth intermediate seal members.

The outer part of the fourth intermediate seal member is in contact with the inner part of the third intermediate seal member and the inner part of fourth intermediate seal is in contact with an inner seal member 128. The fourth intermediate seal has common seal interfaces at the contact surface between third intermediate seal and inner seal member. The fourth intermediate seal member is freely rotatable relative to the third intermediate seal and inner seal member.

The inner seal member 128 is to be arranged fixed about an inner body, such as inner bearing ring 127. To reduce the friction coefficient and wear, it is preferred that the common seal interface comprises one metal part and one elastomeric/polymeric part.

It should be noted that the embodiments illustrated and described were given merely by way of non-limiting indicative examples and that modifications and variations are possible within the scope of the invention as defined by the appended claims. It should be easily understood that the seals can be of combinations of different materials like metal, polymer and elastomer.

Seals exert a certain load on the counterface. The friction resulting from this load is only part of the total contact friction and power loss at the sealing face. Circumferential speed, constant coefficient of friction, temperature, pressure differential across the seal, lubrication, etc are other contributing factors.

The seal described reduces friction, wear and heat by the use of a seal comprising inner and outer circular seal members wherein the seal members are rotatable with respect to each other. The seal further comprises a first intermediate seal member with a common seal interface with said inner seal member and were said first intermediate seal member is rotatable relative said inner and outer seal members. This results in a reduced relative motion at the seal interface. This leads to an extended service life, a reduction in friction and enables a higher maximal speed. The definition parallel connected seals means, that the seal unit has at least two seals that are rotatable relative each other, arranged about an inner body.

Parallel Connected Seals:

The frictional moment (Equation 1) for n parallel connected seals can be expressed by M:

$$\frac{1}{M} = \frac{1}{{M}_{1}} + \frac{1}{{M}_{2}} + … \frac{1}{{M}_{n}} \qquad ( Equation 1 )$$

As follows from Equation 1, the frictional moment is inversely proportional to the sum of the individual frictional moment components in a device with parallel connected seals. Lowest frictional moment occurs when; M₁=M₂=Mₙ. For parallel connected seal members to have substantially the same frictional moment they should have a common product of frictional coefficient, a circumferential length and a normal load exerted on the seal surface. This is so that the circumferential speed of said intermediate seal member relative its inner and outer seal members are substantially the same. Friction yields heat and wear and with the use of this invention, the properties for the seals can be adjusted to match the application. The properties such as relative motion between individual seals can be tuned to match the application. If one of the individual rotating seals during use has a higher friction momentum than the other, it results in a lower relative speed for that individual seal and higher relative speeds for the other individual rotating seals. The friction loss will be substantially the same for all relatively individual rotating seal (Eq.2).

W_{M1}≈W_{M2}≈W_{Mn} (Equation 2)

What is claimed is:

1. A seal including:
an inner and outer circular seal members;
and the seal members are rotatable with respect to each other;
and the outer seal member is arranged to be fixed inside an outer circular body;
and an inner circular circumferential of the inner seal member is arranged to be fixed about an inner circular body rotating inside said outer circular body;
wherein that the seal comprises a first intermediate seal member with a common seal interface with said inner seal member,
wherein said common seal interface comprises a seal lip and an adjacent inner counterface, and said first intermediate seal member is rotatable relative said inner and outer seal members.

2. The seal according to claim 1, comprising a second intermediate seal member (604) with a common seal interface with the first intermediate seal member, wherein the second intermediate seal member is rotatable relative the inner, outer and first intermediate seal members.

3. The seal according to claim 1, wherein the first intermediate seal member has a common seal interface with the outer seal member.

4. The seal according to claim 2 or 3, wherein the inner and outer common seal interfaces of the intermediate seal member have a common product of frictional coefficient, a circumferential length and the normal load exerted by the second seal surface, so that circumferential speeds of the intermediate seal member relative its inner and outer seal members are substantially the same.

5. The seal according to any of the preceding claims, wherein at least one of the common seal interfaces comprises adjacent metal and elastomeric surfaces.

6. The seal according to claim 1, wherein the seal lip has an elastomeric surface and the counterface has a metallic surface.

7. The seal according to claim 1, wherein the inner circular body is an inner bearing ring.

8. The seal according to claim 1, wherein the outer circular body is an outer bearing ring.

9. The seal according to claim 1, wherein the inner circular body is a shaft.

10. The seal according to any of the preceding claims, wherein at least one of the common seal interfaces comprises adjacent metal and polymeric surfaces.

11. The seal according to claim 1-3, wherein the circumferential speed decreases from the inner to the outer rotatable seal member.
